(19) United States
(12) Patent Application Publication
(10) Pub. No.: US 2002/0168619 A1
(43) Pub. Date: Nov. 14, 2002

(54) Simulator device for human feminine mammary gland

(76) Inventor: Thadeu Rezende Provenza, Belo Horizonte (BR)

Correspondence Address: Dickinson Wright, Suite 800, 1901 L Street NW, Washington, DC, 20036-3506, US

(21) Appl. No.: 09/914,380

(22) PCT Filed: Dec. 5, 2000
(86) PCT No.: PCT/BR00/00159

(30) Foreign Application Priority Data
Dec. 29, 1999 (BR) PI 9906054-0

(51) Int. Cl. G09B 23/28

(52) U.S. Cl. 434/267

(57) ABSTRACT

The present patent describes a simulator device for human feminine mammary gland, that is destined to guide patient, nurses, doctors and the whole personnel of the medical, educational area and lay population in the detection of pathological occurrences, through touch. It is known the notorious difficulty of recognition of pathological occurrences of the human feminine mammary gland, so much for own woman that solemnity examines herself, as for the personnel of the medical area or the education area, with a body (1), put upon to a base (2) made by rigid material, as plastic, metal, wood, formic, leather, rubber, etc., serving as support to the stuffing material (3) that gives volume to the body (1); the stuffing material (3) is normally prepared with many light metal, etc., or gelatinous, gaseous or liquid material, or still others that simulate the inside tissue of the mammary gland, having a texture that allows the observation, for the touch, of the elements (5.a) and (5.b) simulators of existent pathologies inside the body (1).

The present patent describes a simulator device for human feminine mammary gland, that is destined to guide patient, nurses, doctors and the whole personnel of the medical, educational area and lay population in the detection of pathological occurrences, through touch. It is known the notorious difficulty of recognition of pathological occurrences of the human feminine mammary gland, so much for own woman that solemnity examines herself, as for the personnel of the medical area or the education area.

To solving such inconvenience, the present invention was developed, it is composed by a didactic model that reproduces the intrinsic and extrinsic characteristics of the feminine suckles, fixed on a frame or on a chart destined to the user's orientation.

The main characteristic of the this simulator device is the facilitation of the exam of the mammary gland, for specialized people or not, once it propitiates, by touch, the comparison, of inside and outside existent pathology simulators, with the possible occurrences of abnormal signs, indicators of pathologies, verified in the woman suckles.

To allow a visualization and a perfect understanding of the means of the present simulator device, illustrative drawings are enclosed, where:

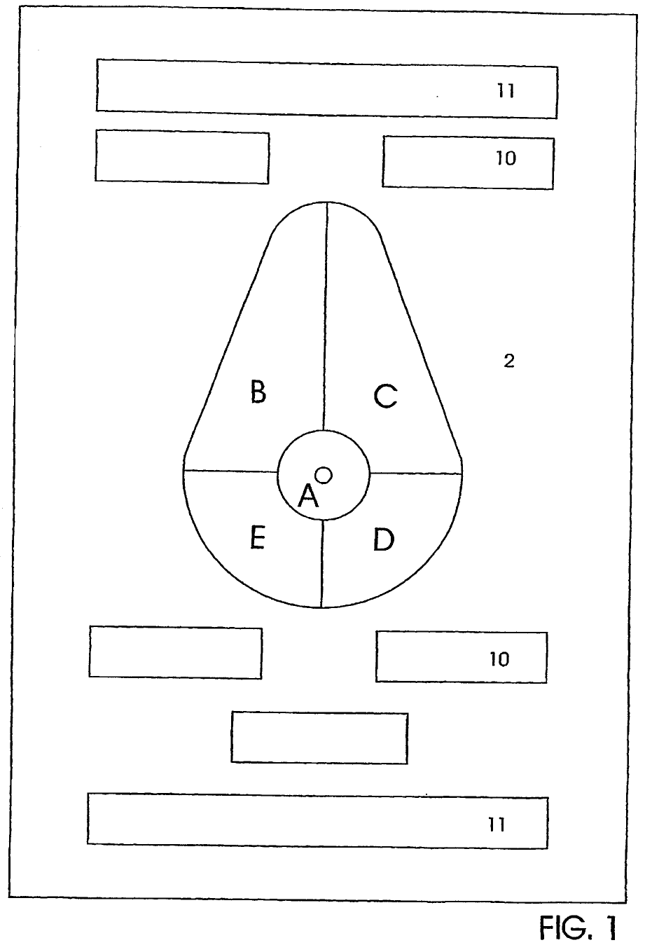

The FIG. 1—represents a frontal view of the simulator device for human feminine mammary gland put upon to the instructions chart.

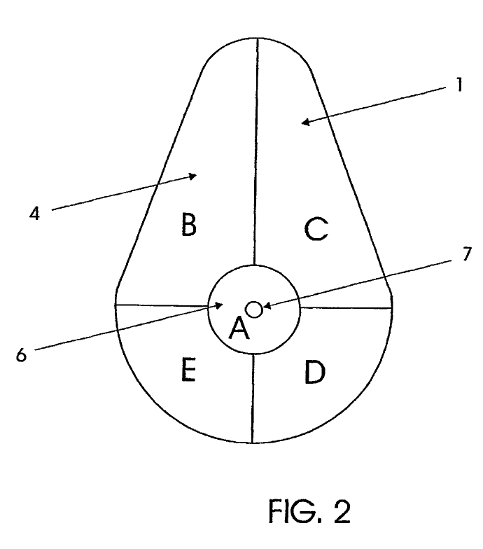

The FIG. 2—represents a frontal view of the simulator device for human feminine mammary gland.

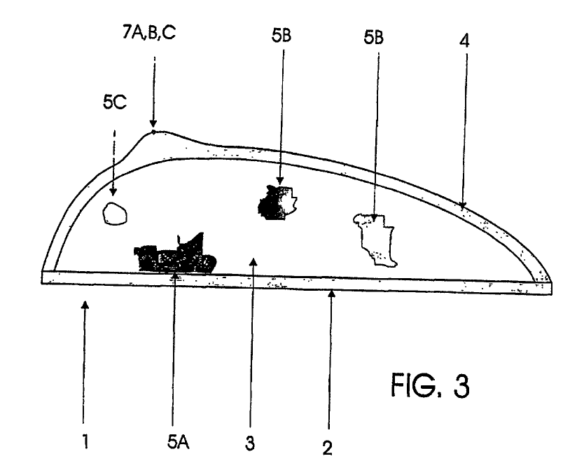

The FIG. 3—represents a section “A-A” of the simulator device for human feminine mammary gland.

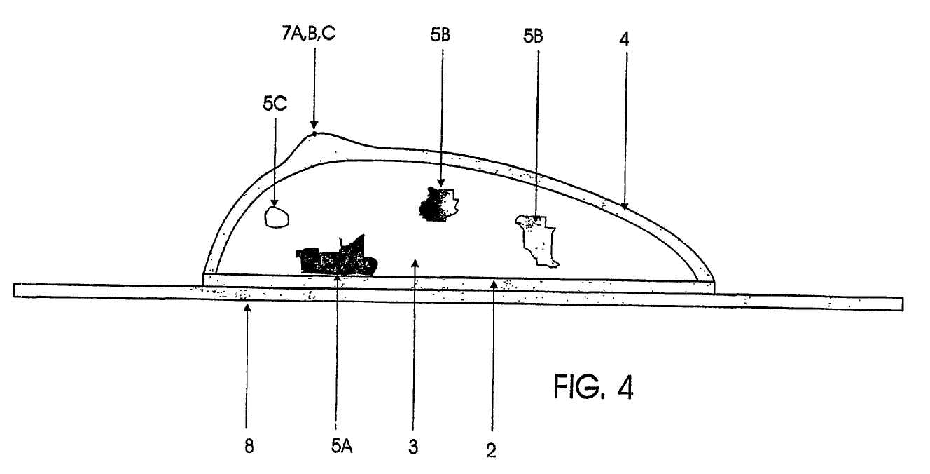

The FIG. 4—represents a section “A-A” of the simulator device for human feminine mammary gland put upon to the instructions chart.

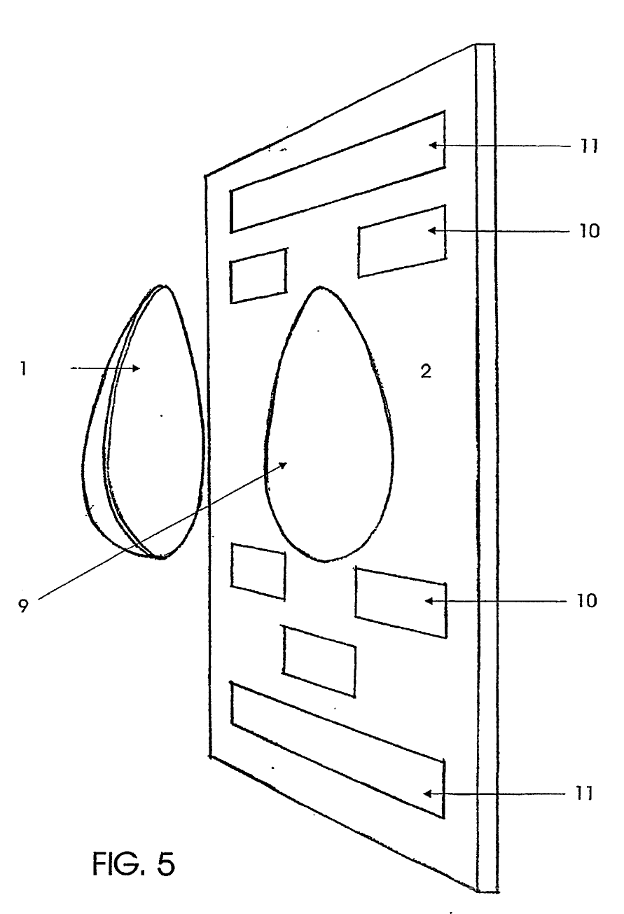

The FIG. 5—represents a view of the simulator device for human feminine mammary gland being put upon to the instructions chart.

As it is shown In the above related figures, the simulator device for human feminine mammary gland has a body (1), put upon to a base (2) made by rigid material, as plastic, metal, wood, formic, leather, rubber, etc., serving as support to the stuffing material (3) that gives volume to the body (1); the stuffing material is normally prepared with many different material like small particles, as grains, flakes, seeds, sawdust, sands, flour, cotton, floss, plastic, scum, silicon, rubber, light metal, etc., or gelatinous, gaseous or liquid material, or still others that simulate the inside tissue of the mammary gland, having a texture that allows the observation, for the touch, of the elements (5.a) and (5.b) simulators of existent pathologies inside the body (1).

These elements (5a), for its time, should come fixed in the base (2) or in the own stuffing material (3), simulating rigid pathologies, in an irregular and angular way, they must be made by wood, mineral, metal, plastic, or other rigid material, as well as to present the elements (5.b) loosened of the base, floating in the stuffing material (3), simulating non rigid pathologies, with the internal material having spherical or round form, of flatter aspect, made in soft and malleable material, as cotton, rubber, plastic, vinyl, scum, etc., or using gases, liquids, gelatinous materials, flakes, etc., preferably inside an elastic or similar spherical film.

The base (2) is preferably to fasten the simulator for the external borders to a flexible and elastic cover (4) that can be a response of human suckles and should be made in rubber, fabric, skin of animals, plastic, metallic screen, silicon, polyurethane, etc., forming the group that makes the contention of the stuffing material (3) and of the elements (5.a) and (5.b) simulators of pathologies.

The cover (4) of the body (1) has five defined areas (A, B, C, D, D, E), representing the pigmented areola (6), the nipple (7) and the remaining of the gland area represented in another four quadrants (B, C, D and E).

The nipple (7) may also shows elements (5c, 5d and 5e) pathology simulators, in the FIG. 2 represented by three aleatoric points, with easy visual identification, corresponding to the emersion of three secretion types after being the nipple pressed or not with the fingers, as it: hemorrhage with dark coffee color (A1); blood hemorrhage color (A2); crystalline hemorrhage like water (A3).

To each element (5a, 5b, 5c, 5d and 5f) simulator corresponds a specific possible pathology occurrence.

The body (1) can be fastened in a frame (8) and be made by rigid material, as cardboard, plastic, metal, wood, formic, leather, acrylic, etc., endowed with a lowering (9) in its central part for the fitting the body (1), that should contain spaces (10) for orientations about providences that should be taken in case of detection of some of the simulate pathological occurrences, as, well as spaces (11) for any information of public interest and publicity.

As constructive variants, suggested for cases in that the user has restrictions for the touch in a simulation of part of the human body, the form of the device simulator of the feminine mammary gland can be represented in a stylized way, like a half of a pear or of a drop, or still to a solid whose base is a triangle, a circle, etc., or any solid that can represent, although symbolically, the feminine mammary gland.

The external coating of the flexible cover (4) It can be colored in any shade and tonality, from the several tones of human skin or any other color, its variations and combinations.

In one of the quadrants to be chosen, preferably that one that doesn't show any pathology simulator element, a costal arch can be inserted,in rigid material, hiding a rib.

It will be understood that several modifications can be introduced without leaving the patent field of protection, being able to substitute some elements by others that would has the same technical characteristics.

1. “SIMULATOR DEVICE FOR HUMAN FEMININE MAMMARY Gland”, to guide patient, nurses, doctors and the whole personnel of the medical, educational area and lay population in the detection of pathological occurrences, by touch, characterized by a body (1), put upon to a base (2) made by rigid material, as plastic, metal, wood, formic, leather, rubber, etc., serving as support to the stuffing material (3) that gives volume to the body (1); the stuffing material is normally prepared with many different material like small particles, as grains, flakes, seeds, sawdust, sands, flour, cotton, floss, plastic, scum, silicon, rubber, light metal, etc., or gelatinous, gaseous or liquid material, or still others that simulate the inside tissue of the mammary gland, having a texture that allows the observation, for the touch, of the elements (5.a) and (5.b) simulators of existent pathologies inside the body (1):

2. “SIMULATOR DEVICE FOR HUMAN FEMININE MAMMARY GLAND”, according with claim 1, characterized by the simulators elements of existent pathologies Inside the body (1), are fixed (5a) in the base (2) or in the stuffing material (3), simulating rigid pathologies, in an irregular and angular way, made with rigid material, and untiled (5b) from the base (2), floating in the stuffing material (3), simulating non, fasten pathologies, in spherical or round ways, of smooth aspect, made in malleable material, inside an elastic spherical film.

3. “SIMULATOR DEVICE FOR HUMAN FEMININE MAMMARY GLAND”, according with claim 1, characterized by the cover (4) of the body (1) be divided in five defined areas (A, B, C, D, E), representing the pigmented areola (6), whose area is represented in four quadrants (A1, A2, A3 and A4), the nipple (7) and the remaining area of the gland represented in another four quadrants (B, C, D and it is).

4. “SIMULATOR DEVICE FOR HUMAN FEMININE MAMMARY GLAND”, according with claim 1, characterized by the nipple (7) having elements (5c, 5d and 5e) pathology simulators, corresponding to the emersion of three secretion types after being the nipple pressed or not with the fingers.

5. “SIMULATOR DEVICE FOR HUMAN FEMININE MAMMARY GLAND”, according with claim 1, characterized by characterized for the body (1) can be fastened in a rigid frame (8), endowed with lowering (9) in its central part for the fitting of the body (1), that should contain spaces (10) for orientations, as well as spaces (11) for any information of public interest and publicity.
